(19) United States
(12) Patent Application Publication
(10) Pub. No.: US 2025/0163675 A1
(43) Pub. Date: May 22, 2025

(54) Floating Filtering Apparatus And Dredging System Therewith

(71) Applicants: William Jeremy Walker, Prairieville, LA (US); John C. Jones, Topeka, KS (US)

(72) Inventors: William Jeremy Walker, Prairieville, LA (US); John C. Jones, Topeka, KS (US)

(21) Appl. No.: 18/832,796

(22) PCT Filed: Jan. 31, 2023
(86) PCT No.: PCT/US2023/012012

§ 371 Date: Jul. 24, 2024

Related U.S. Application Data
(60) Provisional application No. 63/304,905, filed on Jan. 31, 2022.

(51) Int. Cl. E02F 7/06; B01D 29/01; B01D 35/05; B01D 35/26; E02F 7/02

(52) U.S. Cl. CPC E02F 7/065; B01D 29/01; B01D 35/05; B01D 35/26; E02F 7/023

(57) ABSTRACT

A floating filtering apparatus is used to separate solid material in a slurry by size, so that the filtered slurry and/or solid material that has been separated from the slurry can be further processed. The floating filtering apparatus comprises a filtering assembly, a first submergible tank, a first pump, and a receptacle for secondary material. The floating filtering system is contained in or supported by a vessel that floats on water and can move and/or be moved about on the surface of the water.

### TECHNICAL FIELD

This invention relates to floating filtering apparatus and dredging systems comprising floating filtering apparatus.

### SUMMARY OF THE INVENTION

This invention provides a floating filtering apparatus comprising a submergible tank, and dredging systems comprising such floating filtering apparatus.

An embodiment of this invention is a floating filtering apparatus comprising a submergible tank. The floating filtering apparatus comprises
A) a slurry velocity reduction device to receive a slurry and sized and configured to receive a slurry and convey the slurry to a filtering assembly;
B) the filtering assembly sized and configured to receive the slurry from the slurry velocity reduction device and to separate material from the slurry so as to form a filtered slurry and a secondary material;
C) a first submergible tank sized and configured to receive the filtered slurry from the filtering assembly and to receive replacement water, wherein the first submergible tank is at least partially submerged in water during use;
D) a first pump connected to the first submergible tank, the first pump being configured to pump at least a portion of the filtered slurry from the first submergible tank; and
E) a receptacle sized and configured to receive the secondary material separated from the slurry by the filtering assembly.

Another embodiment of this invention is a system comprising a floating filtering apparatus comprising a submergible tank. In some embodiments, the system is a dredging system.

These and other embodiments and features of this invention will be still further apparent from the ensuing description and appended claims.

### BRIEF DESCRIPTION OF THE DRAWINGS

FIG. 1A is a side view of a dredging system in a body of water, the dredging system connected to a floating filtering apparatus according to one embodiment of the invention, and the floating filtering apparatus, shown on a barge, is connected to an onshore processing facility.

FIG. 1B is a top view of the dredging system of FIG. 1A.

FIG. 2A is a side view of the floating filtering apparatus showing a filtering assembly (separator) according to an embodiment of the invention and the submergible tank.

FIGS. 2B and 2C are side views of a floating filtering apparatus according to one embodiment of the invention showing a filtering assembly (separator) and the submergible tank. FIG. 2B shows the first pump; the location of the first pump is a design choice.

FIG. 2D is another side view of a filtering assembly (separator) and the submergible tank of the floating filtering apparatus according to one embodiment of the invention.

FIG. 2E is an end or front view of the filtering assembly (separator) and the submergible tank of the floating filtering apparatus according to one embodiment of the invention.

The figures illustrate embodiments of specific aspects of the invention, and are not intended to impose limitations on the scope of the invention.

### FURTHER DETAILED DESCRIPTION OF THE INVENTION

Slurries are mixtures of liquid and solid material; in the practice of this invention, the liquid typically is water, and the solid material is generally a particulate material, typically sand, rocks, or a mixture of sand and rocks; the solid material also may be minerals and/or mined material.

In some embodiments of the invention, the floating filtering apparatus is used to separate the solid material in the slurry by size, so that the filtered slurry and/or solid material that has been separated from the slurry (secondary material) can be further processed.

The floating filtering apparatus of the present invention comprises a filtering assembly, a first submergible tank, a first pump, and a receptacle for secondary material. The floating filtering system is contained in or supported by a vessel that floats on water and can move and/or be moved about on the surface of the water. For the floating filtering apparatus, a convenient type of vessel is a barge in some embodiments of this invention.

The slurry velocity reduction device is sized and configured to receive a slurry and to convey the slurry to a filtering assembly. The slurry velocity reduction device reduces the velocity of the slurry before the slurry enters the filtering assembly. A preferred slurry velocity reduction device is a hydraulic pipeline receiving tank.

The filtering assembly is configured to receive a slurry and to separate material from the slurry to form a filtered slurry and secondary material. Generally, the filtering assembly separates the solid material of the slurry by particle or agglomerate size, so the filtering assembly normally comprises a porous membrane and/or sieve to achieve a pre-selected size separation. The filtering assembly can have a screening structure comprised of two or more segments that can be in series (e.g., stacked on top of each other). A ramp filtering apparatus is an example of a suitable filtering assembly; another more particular example of a suitable filtering assembly is a sloped static screening assembly, in some embodiments the static screening assembly preferably having a slope of about 15 degrees to about 35 degrees from horizontal. In some embodiments, the filtering assembly has a structure for reduction of the velocity of the secondary material, preferably a chute or baffle, for the secondary material to pass through before entering the receptacle.

The first submergible tank is sized and configured to receive the filtered slurry from the filtering assembly. The first submergible tank is at least partially submerged in water during use. Typically, at least about 50% of the tank is submerged, more preferably about 70% of the tank is submerged, still more preferably about 85% of the tank is submerged. Most preferably, the tank is fully submerged. The first submergible tank may be referred to in some instances in this document as a submerged tank.

The first submergible tank is also sized and configured to receive replacement water. In the methods of the invention, at least a portion of the filtered slurry is pumped out of the first submergible tank by the first pump, and in order to maintain the contents of the first submergible tank as a slurry, replacement water is added to the first submergible tank at least periodically. In some embodiments, the replacement water is received by one or more openings defined by the first submergible tank, and are preferably located at or near the top of the first submergible tank, and/or near the bottom of the first submergible tank.

The first pump is connected to the first submergible tank, and the first pump is configured to pump at least a portion of the filtered slurry from the first submergible tank. The filtered slurry from the first submergible tank can be pumped to another tank, which can be on the same vessel that carries the floating filtering apparatus or on a different vessel. Alternatively, the filtered slurry from the first submergible tank can be pumped to a processing facility (floating or onshore), or to an onshore tank.

The receptacle is sized and configured to receive the secondary material separated from the slurry by the filtering assembly. Typically, the receptacle comprises a receiving pump or a second submergible tank.

When the receptable for the secondary material comprises a receiving pump configured to pump at least a portion of the secondary material, the receiving pump can transfer the secondary material to another tank, which can be on the same vessel that carries the floating filtering apparatus or on a different vessel, or to a processing facility (floating or onshore), or to an onshore tank. Other receptacles include hoppers or other means for conveyance of the secondary material.

When the receptable for the secondary material comprises a second submergible tank sized and configured to receive the secondary material, the secondary material may remain in the second submergible tank for transport and/or further processing, or, preferably, the second submergible tank is connected to a secondary pump, the secondary pump being configured to pump from the second submergible tank at least a portion of the secondary material. The secondary material in the second submergible tank can be pumped to another tank, which can be on the same vessel that carries the floating filtering apparatus or, preferably, on a different vessel. Alternatively, the secondary material from the second submergible tank can be pumped to a processing facility (floating or onshore), or to an onshore tank. In the practice of this invention, the secondary tank does not need to be submerged; in preferred embodiments, the secondary tank is at least partially submerged; preferably, at least about 50% of the tank is submerged, more preferably about 70% of the tank is submerged, still more preferably about 85% of the tank is submerged; most preferably, the tank is fully submerged.

For the pumps used in the practice of this invention to move slurries and materials from submergible tanks, it is recommended that the pump discharge from the submergible tank(s) is at an angle from horizontal. Preferably, the angle is about 5 degrees to about 30 degrees from horizontal, more preferably about 10 degrees to about 25 degrees from horizontal, still more preferably about 10 degrees to about 20 degrees from horizontal. The pumps used to move the slurries and materials are normally dredge pumps. Each pump and corresponding submergible tank are typically connected by a pipe or suction hose, as appropriate.

The openings from the submergible tanks to the first pump and receiving pump are preferably covered by screens or porous membranes to prevent entry or exit of solid material of certain sizes. The screens or porous membranes covering the openings are preferably replaceable (exchangeable or modular), and the screen or membrane size opening can be changed, typically by replacing (exchanging) the screen or porous membrane to allow solids of different sizes to enter and/or exit.

The system of the present invention comprises a floating filtering apparatus of the present invention, a slurry source, and a source of replacement water. The slurry source can be, for example, rocks, minerals, and/or sediment, but the slurry source is most often dredged material. Since the system, or at least the floating filtering apparatus, is on water, the body of water is often a convenient source of replacement water. The system of the invention may also comprise a conveyor or conduit configured to extend from the receptacle for the secondary material to a processing facility or to storage.

The methods of the present invention are for processing a slurry comprising a liquid (e.g., water) and solid material. The methods comprise:
feeding a slurry into a slurry velocity reduction device;
feeding the slurry from the slurry velocity reduction device to a floating filtering assembly floating on a body of water, wherein the slurry is processed to form a) a filtered slurry fed into a first submergible tank at least partially submerged in the body of water, and b) a feed of secondary material separated from the slurry by the filtering assembly;
pumping at least a portion of the filtered slurry from the first submergible tank;
feeding the secondary material separated from the slurry by the filtering assembly to a receptacle; and
introducing replacement water, optionally from the body of water, into the first submergible tank while the first submergible tank is at least partially submerged.

The slurry velocity reduction device, floating filtering assembly, filtered slurry, first submergible tank, secondary material, and receptacle, and the preferences for each, are as described above.

In some embodiments, the replacement water is introduced from the body of water through one or more openings defined by the first submergible tank, in which the one or more openings are disposed below a water line formed around or above the first submergible tank while it is at least partially submerged, and the replacement water from the body of water flows through one or more of the openings and into the first submergible tank.

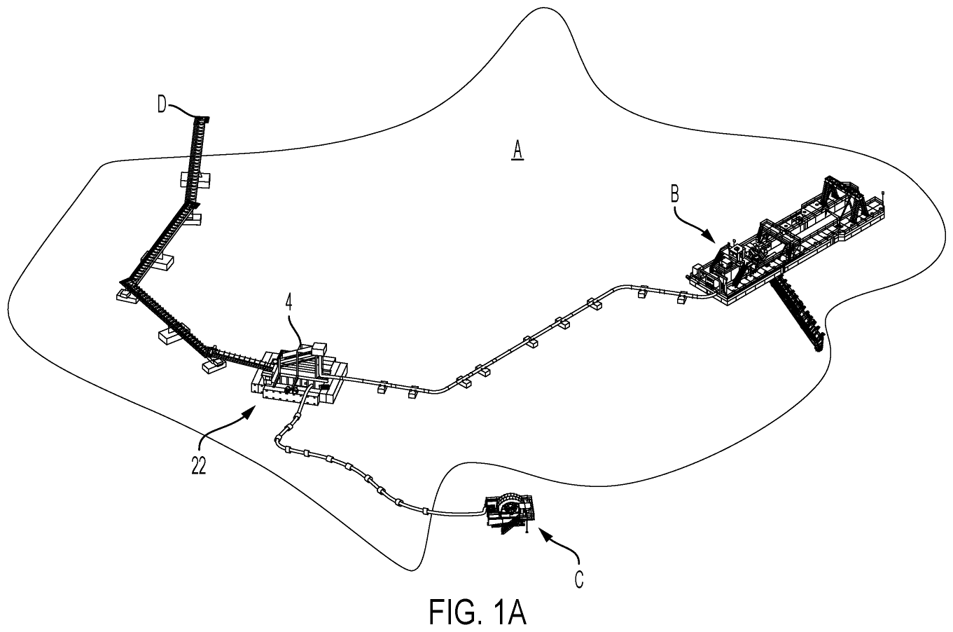

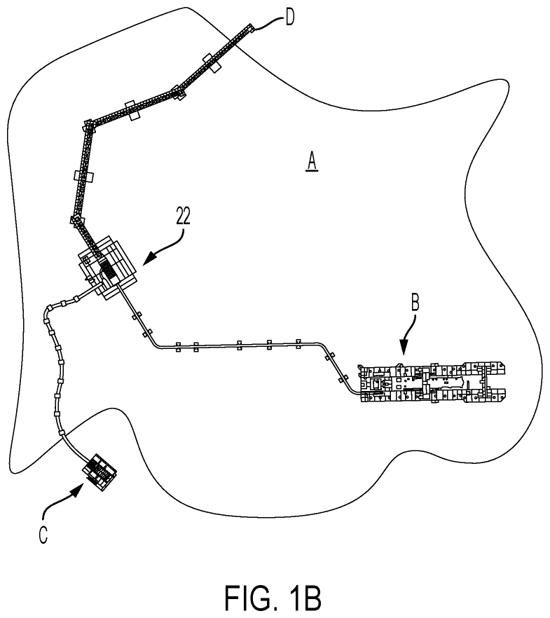

A system in accordance with one embodiment of the invention is depicted in FIGS. 1A and 1B. In FIGS. 1A and 1B, the system is shown in and near a body of water (e.g., a lake or pond) (A). A floating (dredging) barge (B) is shown on the left in the lake. The floating barge (B) sends a slurry comprising water and solid material (typically rock and/or sand) to a floating filtering apparatus (22) with a ramp filtering assembly (4) shown in the lake, which floating filtering apparatus (22) filters the slurry; the larger-sized objects do not pass through the filter, and a filtered slurry of smaller-sized objects (typically particles or rocks) and water goes into the first submergible tank (not shown), and the filtered slurry is pumped from the first submergible tank to the onshore apparatus (C) which further processes the slurry; preferably the further processing includes dewatering the filtered slurry. Both the floating barge (B) and the floating filtering apparatus (22) can move in the water. The larger-sized objects that did not pass through the filter are transferred to an onshore facility (D) for further processing.

The floating filtering apparatus may function as a floating processing plant comprising a submerged slurry tank (the first submergible tank) into which the solid material and water that passes through the screening assembly (filtering assembly) is received as the filtered slurry.

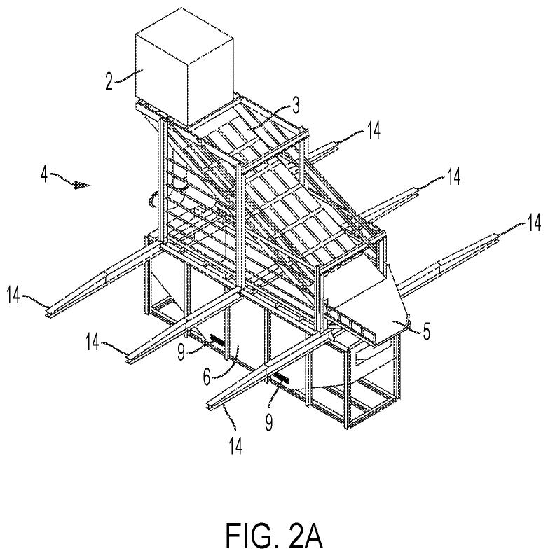

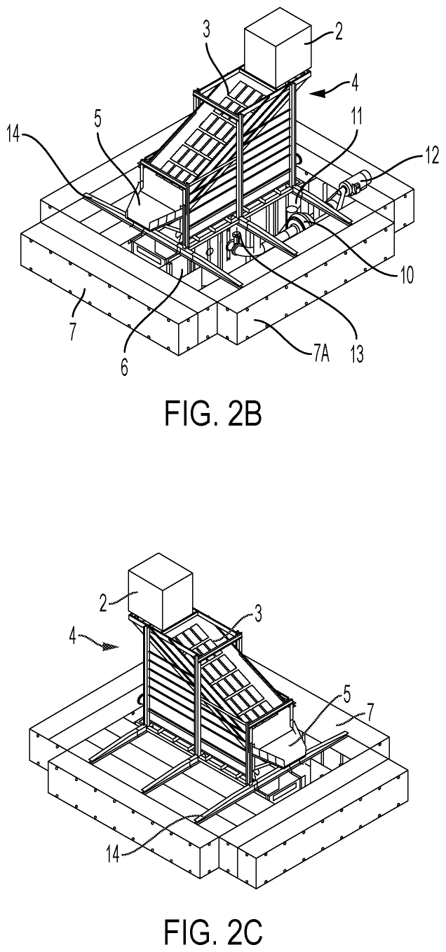

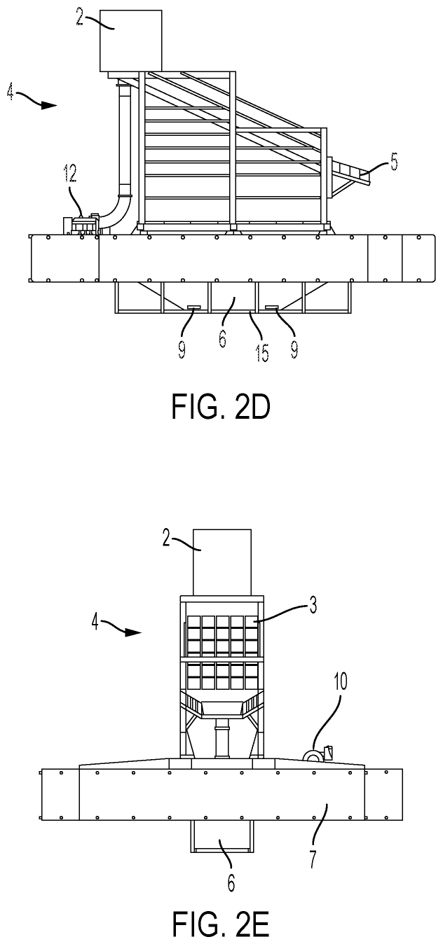

A floating processing plant with the submerged slurry tank is depicted in detail in FIGS. 2A-2E, and the entry/exit for processing solid material from a slurry, comprising a hydraulic pipeline receiving tank (2) designed to reduce the hydraulic pressure and velocity of the incoming slurry comprising water and solid material, typically minerals and/or mined material, and to allow for even distribution of solid material over the initial or upper section (3) of a sloped static screening assembly (preferably having about 15 to about 35 degrees of slope). The screening assembly (4) preferably has a large surface area to handle water used for transport of the slurry via the hydraulic pipeline. The water is usually about 50% to about 99% by weight of the incoming materials (slurry). In some embodiments, the filtering assembly (screening assembly) has a chute or baffle (5) to reduce the velocity of the secondary material at the lower end of the filtering assembly (screening assembly), which chute or baffle (5) directs the secondary material (the material that does not pass through the screens) into a hopper or other means of conveyance for additional processing.

A feature of the first submergible tank (slurry tank) (6) is that it is at least partially submerged in the water. The first submergible tank (6) receives the slurry (solid material and water) that passes through the porous membranes or screens of the filtering assembly (screening assembly) (4). Typically, at least about 50% of the first submergible tank is submerged, more preferably about 70%, still more preferably about 85%; most preferably, the tank is fully submerged. A feature of the invention is that the porous membranes or screens of the screening assembly allow water to enter the first submergible tank (submerged tank), often while the first pump (slurry pump) removes water when the filtered slurry is being pumped out of the first submergible tank.

The submerged slurry tank (first submergible tank) (6) has one or more openings (9) for entry of replacement water. The replacement water that enters the submerged tank (6) may be from any convenient source, including from the body of water in which the vessel floats. Water may enter the submerged tank (6) via one or more openings (9), which openings may be located at any convenient position. Openings (9) preferably are covered by screens or porous membranes. Preferred positions for openings are at or near the top of the submerged tank, and/or near the bottom of the submerged tank. In some embodiments, a portion of a wall or side of the first submergible tank is an opening covered by a screen. Any openings of the submerged tanks (submergible tank) preferably have a screen or porous membrane to prevent entry or exit of solid material. The screens or porous membranes covering the openings are preferably replaceable (exchangeable or modular).

In some embodiments, it may be desirable to have spray nozzles inside the submerged slurry tank (first submergible tank) (6) to agitate material that has settled. The secondary material can be deposited on a conveyor via a chute or deposited into a second submerged tank (second submergible tank) to be transported hydraulically or mechanically away from the floating filtering apparatus.

In some embodiments, the screening assembly (4) preferably has removable sections for changing the size selections of the solid material in the slurry and combinations of different sizing screens depending on the make-up of the solid material. The slope of the screening assembly (4) is designed to allow adequate time for the material to remain on the screening assembly (filtering assembly) but also to keep the material moving. No additional water is required for the improvement of screening. Additional water can be utilized to clean the solid material (secondary material).

The material (filtered slurry) in the submerged slurry tank (6) is then pumped via hydraulic pipeline through a slurry pump (first pump) (10) which is mounted in on or the floating apparatus, preferably in a specifically designed hull section (11). The slurry pump (10) can by driven by any convenient means, such as an electric motor (12), combustion engine or a hydraulic drive. The slurry pump (10), which is one of the few moving parts of this system, preferably has valve(s) (13) in the suction piping to permit flow cut off for maintenance of the unit.

The floating filtering apparatus can be comprised of modular units (7A). The design of the structural support (14) for the screening assembly (4) allows for the proper distribution of weight across these modular floats (7A). In some embodiments, a single unit or multi-unit floating platform can be utilized.

Modular floats can be added to support ancillary equipment to support the equipment gathering the material. Safety features can be added to the floating filtering apparatus (platform) including alarms for unbalanced loading or listing. Optionally, the submerged slurry tank (first submergible tank) (6) has an emergency trap door (15) to permit the material therein to be dumped out if a flotation issue such as leakage, hull failure, or tank failure, occurs.

The invention may comprise, consist, or consist essentially of the materials and/or procedures recited herein.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A floating filtering apparatus comprising
A) a slurry velocity reduction device to receive a slurry and sized and configured to receive the slurry and convey the slurry to a filtering assembly;
B) the filtering assembly sized and configured to receive the slurry from the slurry velocity reduction device and to separate material from the slurry so as to form a filtered slurry and a secondary material:
C) a first submergible tank sized and configured to receive the filtered slurry from the filtering assembly and to receive replacement water, wherein the first submergible tank is at least partially submerged in water during use:
D) a first pump connected to the first submergible tank, the first pump being configured to pump at least a portion of the filtered slurry from the first submergible tank: and
E) a receptacle sized and configured to receive the secondary material separated from the slurry by the filtering assembly.

2. A floating filtering apparatus as in claim 1 wherein
the filtering assembly comprises a ramp filtering apparatus; and/or
the receptacle for the secondary material separated from the slurry by the filtering assembly comprises i) a receiving pump configured to pump at least a portion of the secondary material, or ii) a second submergible tank sized and configured to receive the secondary material.

3. A floating filtering apparatus as in claim 1 wherein
when the filtering assembly comprises a ramp filtering apparatus, the filtering assembly is a sloped static screening assembly having a sloped screening surface with a slope in the range of about 15 degrees to about 35 degrees from horizontal; and/or
when the receptacle for the secondary material comprises a second submergible tank, the second submergible tank is connected to a secondary pump, the secondary pump being configured to pump from the second submergible tank at least a portion of the secondary material.

4. A floating filtering apparatus as in claim 1 wherein the first submergible tank defines one or more further openings to receive replacement water.

5. A system comprising a floating filtering apparatus of claim 1, a slurry source, and a source of replacement water.

6. A system as in claim 5 further comprising either a conveyor or conduit configured to extend from the receptacle for the secondary material separated from the slurry by the filtering assembly to a processing facility.

7. A system as in claim 5 wherein the slurry source is dredged material.

8. A system as in claim 5 wherein the slurry velocity reduction device is a pipeline receiving tank.

9. A method for processing a slurry comprising water and solid
material, which method comprises
feeding the slurry into a slurry velocity reduction device:
feeding the slurry from the slurry velocity reduction device to a floating filtering assembly floating on a body of water, wherein the slurry is processed to form a) a filtered slurry fed into a first submergible tank at least partially submerged in the body of water, and b) a feed of secondary material separated from the slurry by the floating filtering assembly:
pumping at least a portion of the filtered slurry from the first submergible tank:
feeding the secondary material separated from the slurry by the floating filtering assembly to a receptacle; and
introducing replacement water into the first submergible tank while the first submergible tank is at least partially submerged.

10. The method as in claim 9, wherein the replacement water is introduced from the body of water through one or more openings defined by the first submergible tank, the one or more openings being disposed below a water line formed around or above the first submergible tank while it is at least partially submerged, so that the replacement water from the body of water flows therethrough and into the first submergible tank.

11. The floating filtering apparatus as in claim 4 wherein the one or more openings are located at or near a top of the first submergible tank, and/or near a bottom of the first submergible tank.

12. The method as in claim 9 wherein the replacement water is from the body of water.
